(19) United States
(12) Patent Application Publication
(10) Pub. No.: US 2024/0286317 A1
(43) Pub. Date: Aug. 29, 2024

(54) CURING A LINER BY LASER

(71) Applicant: SAERTEX multiCom GmbH, Saerbeck (DE)

(72) Inventors: Nils Füchtjohann, Greven (DE); Eugen Wolf, Osnabrück (DE)

(21) Appl. No.: 18/584,472

(22) Filed: Feb. 22, 2024

(30) Foreign Application Priority Data
Feb. 28, 2023 (EP) 23159005.0

(51) Int. Cl. B29C 35/08; B23K 26/06; B29C 63/00

(52) U.S. Cl. CPC B29C 35/0805; B23K 26/0648; B29C 63/0069; B29C 2035/0838

(57) ABSTRACT

A process for curing a liner for the rehabilitation of pipes or canals, wherein laser light is used for curing a resin-impregnated liner, and the use of an axicon for generating an annular laser beam profile for curing a liner for rehabilitating pipes or canals. A method of using at least one axicon for generating an annular beam profile of a laser beam for curing a liner for rehabilitation of pipes or canals.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### FIELD

The invention relates to a process for curing a liner for the rehabilitation of pipes or canals, wherein a laser beam is used for curing a resin-impregnated liner, and the use of an axicon for generating an annular laser beam profile for curing a liner for the rehabilitation of pipes or canals.

### BACKGROUND

The use of lasers in the rehabilitation of pipes and canals, wherein the liner is used for curing a resin-impregnated fibre tube, has already been known from EP4017906A1, for example. However, the prior art processes are disadvantageous in that the laser source had to be directed directly towards the inner surface of the liner to be cured. This has made the device required for curing very expensive and complicated.

WO9851960A1 describes the curing of a liner by laser, wherein a curing agent is encapsulated and the capsules release the curing agent by laser irradiation. The curing agent is not a photoinitiator. The capsules must absorb the laser light.

Until now the prejudice that it is particularly difficult to cure a liner comprising a resin-impregnated fibre tube by laser has persisted. For example, EP4017906A1 and WO9851960A1 describe that the laser source itself can be directed towards the inner surface of the liner or the laser light irradiates the inner surface of the liner through a rotating mirror. Until now, these processes have not been able to prevail on the market.

### SUMMARY

The object of the present invention, therefore, is to provide a simpler technology for curing a liner for the rehabilitation of pipes or canals by laser light.

### DETAILED DESCRIPTION

In a first embodiment, the object of the invention is achieved by a process for curing a liner for the rehabilitation of pipes or canals wherein the following steps are performed:
a. Inserting a liner comprising at least a resin-impregnated fibre tube into the pipe to be rehabilitated or the canal to be rehabilitated,
b. Erecting the liner by pressing the liner against the inner surface of the pipe or canal to be rehabilitated, and
c. Curing the resin system in the resin-impregnated fibre tube by moving a device through the erected liner wherein laser light is deflected in the device by at least one optics at an angle from 0.5 to 179 degrees with respect to the incident laser beam such that the laser light impinges on the inner surface of the erected liner and thus can cure the resin system in the fibre tube.

This device allows to position the laser light source outside the liner and to deflect the laser light irradiating in the longitudinal direction of the liner in the erected liner to the inner surface for curing the resin system, for example.

An important advantage of using laser light in the process according to the invention over processes using conventional light sources (such as mercury lamps, no lasers) is that the intensity loss has been proportional to the square of the distance until now, whereas the intensity loss is approximately linearly proportional to the distance when using a laser, for example. Moreover, the colour of the laser light can be adjusted to the optical conditions for curing the liner in the best possible way.

The process according to the invention allows for an easier handling, a lower investment, a better control of curing and a better workplace safety (no longer a risk due to electric shocks or imploding high-pressure lamps, for example).

### Process

Inserting the liner in step a. can be performed either by inserting the liner into the pipe or the canal or, alternatively, by inverting it in the pipe or channel.

For example, erecting the liner in step b. can be performed by pressurising the liner with a fluid (such as compressed air, vapour or water, for example).

In step c., curing can be performed thermally or by photocuring, for example. If curing is performed thermally, a thermally decomposing initiator can be contained in the resin system, for example. If curing is performed by photocuring, one or several initiators decomposing by light can be contained in the resin system, for example.

In step c, the device is preferably moved through the liner with a speed in a range from 0.1 to 5000 cm per minute, particularly preferably from 0.2 to 1000 cm per minute.

In step c. of the process, the optics is preferably moved near the symmetry axis of the erected liner along the liner. In particular, in step c. the median position of the optics deviates from the symmetry axis by less than 50%, very particularly preferably by less than 10% of the inner diameter of the erected liner.

### Resin System

Preferably, the resin system according to the invention is a resin system for curing liners. For example, the resin system can be a resin system of an unsaturated polyester, vinyl ester or an epoxide resin system. Preferably, the resin system according to the invention can also contain thermal initiators such as, for example, azo compounds or peroxides. Preferably, however, benzoyl peroxide is not used as a thermal initiator since it is dangerous for the environment.

Preferably, the resin system contains clay particles in an amount of at most 1% by weight, more preferably no clay particles.

Preferably, the resin system contains natural fibres in an amount of at most 1% by weight, more preferably no natural fibres.

Additional fillers (aluminium hydroxide or calcium carbonate, for example) may also be included.

The resin system preferably contains polymerisation initiators in a quantity ranging from 0.01 to 5% by weight, particularly preferred from 0.05 to 1% by weight. The initiator may be a photoinitiator or a thermal initiator or a mixture of a photoinitiator and a thermal initiator.

Preferably, at least one absorption maximum of the photoinitiator is in a range from 250 to 600 nm, very particularly preferably in a range from 400 to 500 nm.

### Device

The optics is preferably connected to a light guide, particularly preferably to a fibre optic cable that directs the laser light from a laser source to the optics.

The laser source may preferably be positioned outside the liner.

The device may be a drone (a flying drone, for example), for example. The optics is preferably installed on the flying drone. The optics on the flying drone can be connected to the laser source via the light guide, for example.

For example, the device may also be a carriage on which the optics is installed. The carriage may have wheels, for example. The optics on the carriage can be connected to the laser source via the light guide, for example.

### Laser Light

Preferably, the laser light can be generated by at least one laser. Moreover, several lasers can be used for generating the laser light. If several lasers are used, at least 2 of the several lasers can emit laser light with different wavelengths. This would have the advantage that different initiators or different absorption bands of an initiator can be addressed.

The diameter of the laser beam entering the optics is preferably in a range from 0.1 to 50 mm (very particularly preferably from 1 to 10 mm).

The wavelength of the laser light (particularly the laser light entering the optics) is preferably in a range from 200 to 2200 nm, especially preferably in a range from 325 to 600 nm, very particularly preferably in a range from 400 to 500 nm. This range is particularly preferable since the previous resin systems and liners for the rehabilitation of pipes and canals are optimised to have a particularly high transmission in this narrow wavelength window. Most liners have a maximum of the transmission loss below about 300 nm. Thus, a wavelength below 325 nm is not advantageous.

It may be preferred that at least one laser generates a laser light having a wavelength in a range from 975 to 1800 nm and the laser light is converted to a laser light having a wavelength in a range from 325 to 600 nm by a frequency converter before entering the optics.

Alternatively, it may also be preferred that the laser light generated by the at least one laser has a wavelength in a range from 975 to 1800 μm, particularly preferably in a range from 1200 to 1500 μm. In that case, the laser light is an infrared laser light, for example. The advantage of the alternative lies in the power losses and the cost of the glass fibre. Whereas fibres for the transmission of UV laser light are comparatively expensive and result in not insignificant power losses (10-30% per 100 m, >6 dB/km, for example), fibres for the transmission of infrared laser light are cost-effective and have very low losses (<0.1% per 1000 m; <1 dB/km). For the same reason, infrared laser light and infrared glass fibres are used for telecommunications tasks. Additionally, the protection from laser light is less critical with infrared laser systems than with UV laser systems. Then, the laser light thus generated can be converted to laser light having a wavelength in a range from 325 to 600 nm preferably by a frequency converter (such as a nonlinear optical crystal, for example) in front of the optics.

The laser light or the at least one laser can be pulsed or continuous, for example.

The laser light or the at least one laser radiates preferably in the longitudinal direction of the liner into the optical element.

Preferably, laser light with an intensity of a continuous beam or an average intensity of pulsed laser light in a range from 109 to 1016 W/m² is used in the method according to the invention. Usually, the intensity is defined as power per unit area, that is, watts per square metre, that is, W/m². The pulse duration of the laser is preferably in a range from 10 to 350 femtoseconds. The pulse energy of the laser is preferably in a range from 1 to 20 mJ (millijoule). The repetition rate of the laser is preferably in a range from 0.1 to 50 kHz.

### Optics

The optics may be reflective, refractive and/or diffractive.

If the laser light is generated by several lasers, particularly, then, several optics may also be used.

Due to the optics the laser light preferably propagates on the surface of a cone. This generates an annular irradiation on the inner surface of the liner.

Preferably, the angle may be in a range from 5 to 150 degrees, very particularly preferably in a range from 10 degrees to 85 degrees.

The optics may comprise a rotating mirror. This allows to deflect a laser beam during the movement of the device such that the laser beam impinges on the inner surface of the erected liner and can thus cure the resin system. The angle of the mirror with respect to the direction of the laser beam in front of the mirror is preferably in a range from +/−0.1 degrees to 89.9 degrees, very particularly preferably in a range from 30 degrees to 60 degrees.

Preferably, the at least one optics comprises at least one axicon that generates a laser beam with an annular beam profile impinging on the inner surface of the erected liner. Thus, the resin system can cure. Particularly preferably, the optics does not contain galvanometric or rotating elements. Axicons are conical lenses that generate an annular beam profile. Axicons have the advantage that the laser source can actually be positioned outside the liner when curing a liner, thus minimising the risk of accident in the liner itself during curing. Moreover, the optics can be inserted much easier and faster than with the UV light chains currently in use. Furthermore, in contrast to prior art the light source hardly generates heat in the liner. In addition, this technology allows to cure liners in pipes with significantly smaller diameters. The axicon can be convex or concave. The aperture angle of the axicon or the emergent light cone is preferably in a range from 1 degree to 180 degrees, very particularly preferably in a range from 20 degrees to 150 degrees, more preferably in a range from 40 degrees to 130 degrees. The aperture angle of the axicon is defined as the limiting angle of the emergent light. Hence, this aperture angle of the axicon or the emergent light cone is twice as large as the angle of the emergent light with respect to the incident laser beam (as in step c., for example, also designated as deflection angle).

The optics may preferably also comprise at least two axicons. Then, one axicon may be concave and one axicon may be convex. For optimising power distribution, the diameter of the ring can be adjusted by varying the distance of both axicons from each other.

The material of the at least one axicon is preferably glass (in particular quartz glass) or plastic.

Preferably, the diameter of the axicon is in a range from 2 to 600 mm, very particularly preferably in a range from 20 to 50 mm. The diameter of the axicon is preferably larger than the diameter of the laser beam.

The edge thickness of the axicon preferably is in a range of 2 to 10 mm.

The optics may also comprise at least one diffractive optical element (DOE). It allows to shape the laser beam, for example.

### Use

In another embodiment, the object of the invention is achieved by the use of at least one axicon for generating an annular beam profile of a laser beam for curing a liner for the rehabilitation of pipes or canals.

### Exemplary Embodiment

A commercially available resin impregnated liner to be cured by UV light as described in EP2573442A1, for example, was used. A pipe with a diameter of 300 mm was lined with a liner with a wall thickness of 4 mm. The resin system used (L050-LCW-03 FC made by AOC, for example) contained 0.1% by weight of Irgacure 819 as a photoinitiator. During the rehabilitation, the liner was inserted into the pipe to be rehabilitated and then inflated with compressed air. A laser beam was generated by a Ti³⁺:Al₂O₃ laser oscillator with a regenerative amplifier and a downstream optical parametric oscillator (OPO of the TOPAS Prime type made by the Coherent Inc. company, Astrella titanium-sapphire laser made by the Coherent Inc. company, HE version with 6 mJ; repetition rate 1 kHz; mean power at 1 W, pulse peak intensity: 3×10¹⁵ W/m², pulse duration 40 femtoseconds). The wavelength at the OPO exit was 450 nm. The laser beam was directed through a 100 m long fibre optic cable customary for this purpose into an axicon having an aperture angle (twice the deflection angle) of 59.8 degrees (manufacturer: Thorlabs; type: AX1240-A, diameter ½″, physical angle: 40 degrees, deflection angle: 29.9 degrees, centre thickness 10.3 mm, AR coating 350-700 nm R_{avg}<0.5%. The deflection angle was measured at 532 nm) which annularly projected the laser beam on the inner surface of the erected liner. A carriage pulled the axicon approximately concentrically within the erected liner through the complete liner such that the annular laser light irradiated the complete inner surface of the liner. The speed was set to 3.6 mm per minute.

Thus, the photoinitiator could be activated, and the resin could be cured.

The features of the invention disclosed in the present description and in the claims both individually and in any combination may be essential to the realisation of the various embodiments of the invention. The invention is not limited to the described embodiments. It may be varied to the extent as falls into the scope of the claims, taking into account the knowledge of one skilled in the art.

What is claimed is:

1. A process for curing a liner for rehabilitation of a pipe or a canal, comprising:
a. inserting a liner comprising at least a resin-impregnated fibre tube into the pipe to be rehabilitated or the canal to be rehabilitated;
b. erecting the liner by pressing the liner against the inner surface of the pipe or canal to be rehabilitated; and
c. curing a resin system in the resin-impregnated fibre tube by moving a device through the erected liner,
wherein a laser light is deflected in the device by at least one optics at an angle from 0.5 to 179 degrees such that the laser light impinges on the inner surface of the erected liner and cures the resin system in the fibre tube.

2. The process according to claim 1, wherein the optics comprises an axicon that generates an annular beam profile of a laser beam impinging on the inner surface of the erected liner.

3. The process according to claim 1, wherein the optics is connected to a laser source via a light guide.

4. The process according to claim 2, wherein a diameter of the axicon is in a range from 5 to 50 mm.

5. The process according to claim 2, wherein an aperture angle of at least one axicon is in a range from 20 degrees to 150 degrees.

6. The process according to claim 1, wherein the optics comprises a diffractive optical element.

7. The process according to claim 1, wherein the optics comprises at least two axicons.

8. The process according to claim 1, wherein a wavelength of the laser is in a range from 325 to 600 nm.

9. The process according to claim 1, wherein the resin system contains a photoinitiator and one absorption maximum of the photoinitiator is in a range from 325 to 600 nm.

10. The process according to claim 1, wherein at least one laser generates a laser light having a wavelength in a range from 975 to 1800 nm and the laser light is converted to a laser light having a wavelength in a range from 325 to 600 nm by a frequency converter before entering the optics.

11. A method of using at least one axicon for generating an annular beam profile of a laser beam for curing a liner for rehabilitation of pipes or canals.
